(19) United States
(12) Patent Application Publication
(10) Pub. No.: US 2007/0046227 A1
(43) Pub. Date: Mar. 1, 2007

(54) ELECTRICAL DEVICE FOR PROCESSING FOOD PRODUCTS, EQUIPPED WITH A SENSOR FOR THE ROTATION SPEED OF THE DRIVE SHAFT

(75) Inventors: Christophe Lagier, Aubusson (FR); Bruno Paturel, Aubusson (FR)

Correspondence Address: SUGHRUE MION, PLLC, 2100 PENNSYLVANIA AVENUE, N.W., SUITE 800, WASHINGTON, DC, 20037, US

(73) Assignee: ELECTROLUX PROFESSIONNEL

(21) Appl. No.: 11/467,686

(22) Filed: Aug. 28, 2006

(30) Foreign Application Priority Data
Aug. 29, 2005 (FR) 05 08830

(51) Int. Cl. H02P 7/00

(52) U.S. Cl. 318/268

(57) ABSTRACT

This device comprises:

a housing (3),

an electric motor (7) which has a rotary output shaft (23) and which is arranged in the housing (3) and is provided in order to drive a product processing element,

a control and command device for the motor, comprising a device (57) for measuring the rotation speed of the drive shaft (23) in a contactless manner.

The measuring device (57) comprises a Hall effect sensor (58) which is fixedly joined to the housing (3), and an associated coding element (59), which is fixedly joined to the shaft (23) in terms of rotation and which is provided in order to influence the sensor (58).

### SUMMARY OF THE INVENTION

The present invention relates to an electrical device for processing food products, comprising:

a housing,

an electric motor which has a rotary output shaft and which is arranged in the housing and is provided in order to drive a product processing element,

a control and command device for the motor, comprising a device for measuring the rotation speed of the drive shaft in a contactless manner.

### BACKGROUND OF THE INVENTION

In the prior art, devices of this type exist whose measuring device is of the optical type, the drive shaft being fixedly joined to a coding wheel which interferes with the path of a light ray received by an optical detector.

Devices of this type are not entirely satisfactory, owing to the fact that the precision of the speed measurement which is used to control the speed of the device can be affected by soiling of the device.

The object of the invention is to overcome this disadvantage and, to this end, the invention relates to a device of the above-mentioned type in which the measuring device comprises a Hall effect sensor which is fixedly joined to the housing, and an associated coding element, which is fixedly joined to the shaft in terms of rotation and which is provided in order to influence the sensor.

According to other optional features of the device according to the invention:

the Hall effect sensor comprises a source element which produces a magnetic field, in particular a permanent magnet, and an element which is sensitive to the magnetic field of the source element and which is spaced therefrom, the coding element passing, at least partially, between the source element and the sensitive element when it rotates in a manner fixedly joined to the shaft;

the control and command device comprises an element for controlling the desired speed of the motor, and a command element which is connected to the control element and to the Hall effect sensor and which is suitable for controlling the electrical supply to the motor in accordance with the desired speed value and the measured speed value;

the command element is suitable for controlling the speed of the motor relative to the desired speed using the measured speed as a control variable;

the command element is suitable for calculating the discrepancy between the set value and the measured value of the speed, and the control and command device comprises an overload indicator which is connected to the command element and which is activated thereby when the element determines that the discrepancy exceeds a predetermined threshold value for a first predetermined length of time;

the command element is suitable for cutting the electrical power supply to the motor when it detects that the discrepancy exceeds the predetermined threshold value for a second predetermined length of time; and

the second predetermined length of time is greater than the first predetermined length of time.

The invention relates more specifically to a device of the mixer type, and even more specifically to a mixer of the type used for food preparation for large-scale catering.

### BRIEF DESCRIPTION OF THE DRAWINGS

An embodiment will now be described in greater detail with reference to the appended drawings, in which

FIG. 1 is a perspective view, sectioned along a longitudinal plane, of a device according to the invention;

FIG. 2 is a partial view, drawn to a larger scale, of the device of FIG. 1, sectioned along the plane 2-2;

FIG. 3 is a view similar to FIG. 2, along the plane 3-3 indicated in FIG. 1; and

FIG. 4 is a diagram which illustrates the command and control device for the motor of the device illustrated in the preceding Figures.

### DESCRIPTION OF PREFERRED EMBODIMENTS

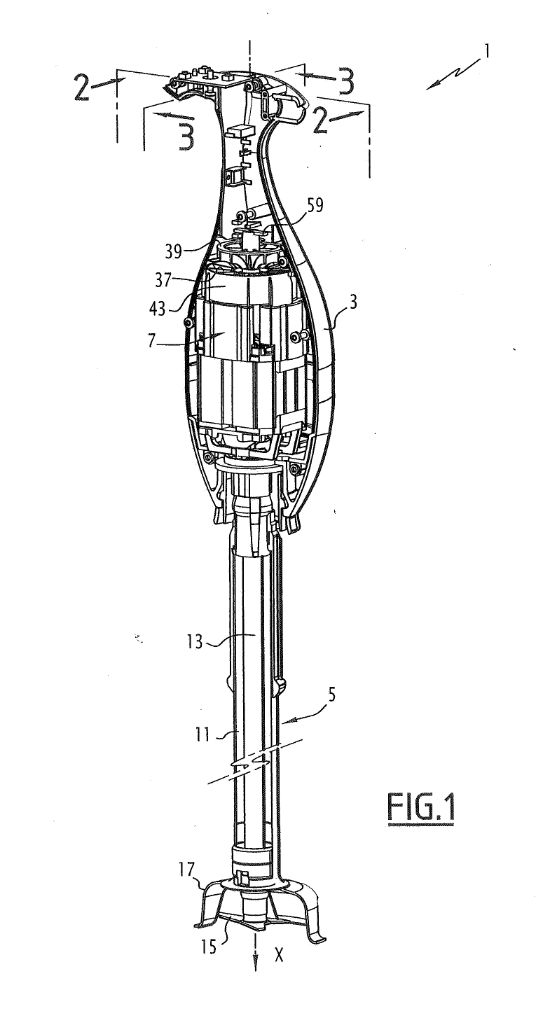

FIGS. 1 to 3 illustrate a device 1 according to the invention, of the type commonly referred to as a “mixer”.

This mixer comprises a housing 3 which forms a handle, a tool 5 for processing food products, and an electric motor 7 which is arranged in the housing 3.

The tool 5 comprises a tubular casing 11 which is fixed to the housing 3 in a removable manner at one of the ends thereof, a drive shaft 13 which is mounted so as to rotate coaxially in the tube 11, and a product processing element 15, such as a blade or a knife, which is fixedly joined to the shaft 13. The product processing element 15 protrudes from the tube 11, at the side of the free end thereof.

The tool 5 further comprises a bell-like member 17 which is fixedly joined to the tube 11 at the free end thereof, and which is provided in order to protect access to the element 15.

The motor 7 is connected to the shaft 13 so as to be able to drive the processing element 15 in terms of rotation.

When the device 1 is in the position for use, as illustrated in FIG. 1, the axis X which is common to the shaft 13 and the tube 11 and which also constitutes the axis of rotation of the processing element 15, is generally orientated vertically, the processing element 15 facing downwards.

In the remainder of the description below, the device 1 will be taken to be orientated in this manner.

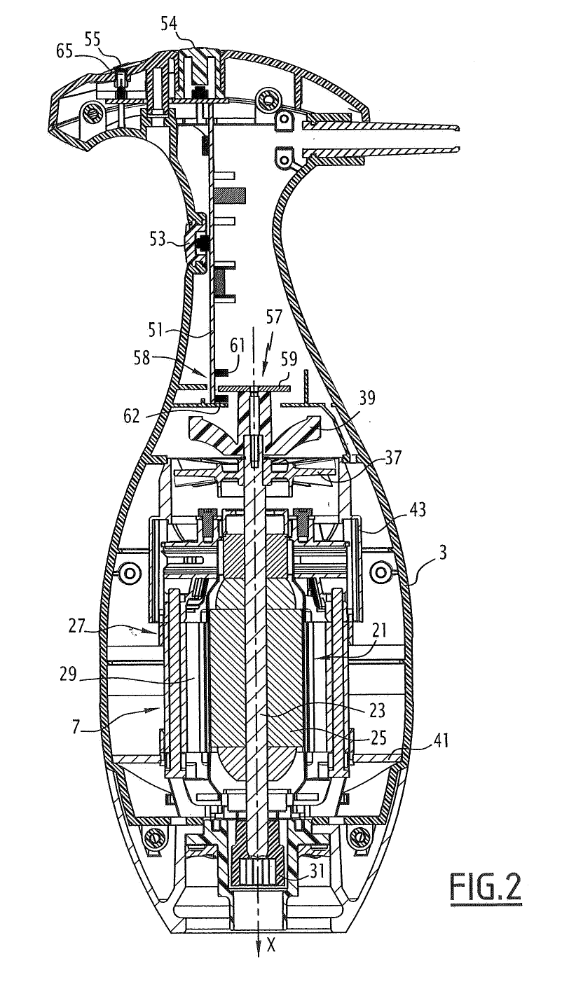

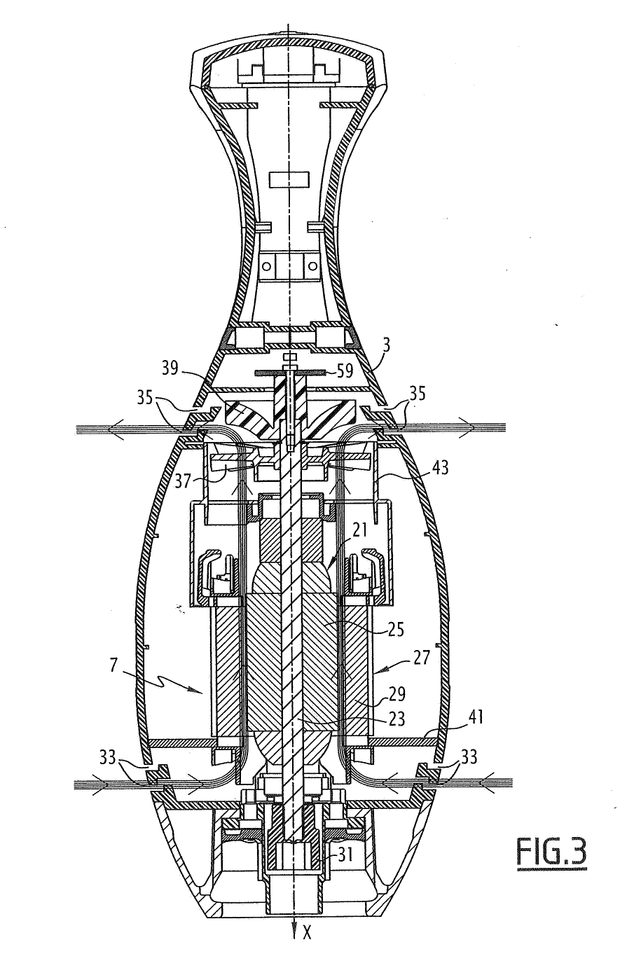

It should be noted in FIGS. 2 and 3, to which specific reference will now be made, that the tool 5 has not been illustrated, for reasons of simplification.

The motor 7 is preferably a motor of the universal type, having, on the rotor 21, a drive shaft (or motor output shaft) 23 which is orientated axially and a fixedly joined winding 25. The stator 27 of the motor 7 comprises a winding 29 which extends radially at the outer side of the rotor winding 25.

At the lower end thereof, the drive shaft 23 is fixedly joined to a coupling component 31 which is provided with a driving form which is provided for receiving a complementary driving form of the shaft 13 of the tool 5, so as to form a disengageable connection in terms of rotation between the shaft 13 and the drive shaft 23.

The device 1 further comprises a ventilation device which is provided in order to cool the motor during operation of the device.

This device comprises, in a lower portion of the housing, air inlet holes 33 which are arranged in a peripheral manner, radially at the outer side relative to the shaft 23.

In a corresponding manner, the ventilation device comprises, in a portion of the housing 3 which is located higher, air outlet holes 35 which are arranged in a peripheral manner radially at the outer side relative to the shaft 23.

The rotor winding 25 and the stator winding 29 extend axially between the air inlets 33 and the air outlets 35.

The ventilation device further comprises an axial fan 37 and a radial fan 39 which are fixedly joined to the shaft 23 and which are arranged at the side of the upper end thereof. The radial fan 39 is arranged substantially at the axial level of the air outlets 35, whilst the axial fan 37 is arranged immediately upstream, taking into consideration the air flow direction from the air inlets 33 to the air outlets 35.

That is to say, the axial fan 37 is located below the radial fan and, more precisely, between the radial fan and the rotor winding 25 and stator winding 29.

The axial fan 37, when it rotates, contributes to a flow of air in a general axial direction, the streams of air flowing in a helical manner about the axis X.

The radial fan 39, when it rotates, receives at the inlet this generally axial flow of air from the axial fan and directs it in a substantially radial manner in the direction of the air outlet holes 35.

The path of the streams of cooling air which are caused to move by the rotation of the fans 37, 39, is illustrated schematically in FIG. 3.

It can be seen in this Figure that the cooling air flows in a substantially radial manner from the air inlets 33 in the direction of the shaft 23, then flows substantially axially inside the motor 7, passing between the stator winding 29 and rotor winding 25. The air then flows through the axial fan 37, then is diffused radially in the direction from the axis towards the peripheral air outlets 3 by the radial fan 39.

It should be noted that an annular wall 41 of the ventilation device is fixed to the inner side of the housing 3 so as to extend radially between the stator 27 and the housing 3. This wall 41 prevents the flow of air from the air inlets 33 between the stator 27 and the corresponding portion of the housing which surrounds the stator. The wall 41 thus forces the flow of air from the air inlets 33 between the rotor 21 and the stator 27.

It should also be noted that the ventilation device comprises, extending axially between the stator 27 and the axial fan 37, an axial tubular conduit 43 which allows the air to be channelled axially between the stator and the fan 37, substantially as far as the level of the air outlets 35, in order to prevent the recirculation of air inside the housing towards the inlets 33 (downwards).

It has been found that the association of the axial fan 37 and the radial fan 39 significantly increased the efficiency of the ventilation device at a constant shaft rotation speed by substantially increasing the flow of air passing through the selected heating zones, located in the region of the windings 25, 29.

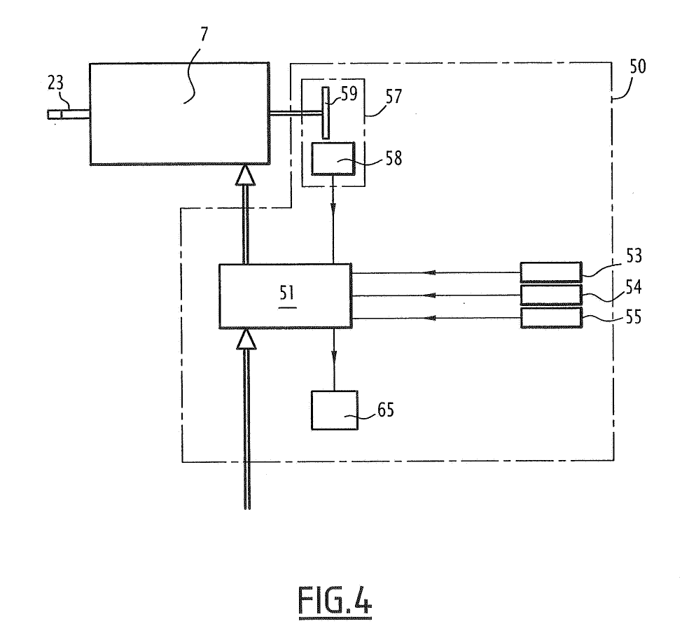

The device 1 further comprises a device 50 for controlling and commanding the motor 7, which device is schematically illustrated in FIG. 4.

For the following description of this control and command device 50, reference will be made more specifically to FIGS. 2 and 4.

The control and command device 50 comprises an electronic motor command element 51 which is suitable for controlling the electrical supply of the motor. The command element 51 is produced in the form of an electronic printed circuit board which is arranged and fixed inside the housing 3.

The control and command device 50 further comprises a start button 53, a motor stop button 54 and buttons 55 for controlling the desired speed of the motor, which are arranged in an upper portion of the housing and which can be activated by the user. These buttons 53, 54, 55 are electrically connected to the command element 51 so that it receives respective input signals which are representative of their state.

The control and command device 50 is further provided with a device 57 for measuring the rotation speed of the drive shaft 23 in a contactless manner, this device 57 being of the magnetic type. More precisely, it comprises a Hall effect sensor 58 which is fixed relative to the housing 3 and an associated coding element 59 which is fixedly joined to the drive shaft 23 in terms of rotation.

The coding element 59 is, for example, a bar of magnetic or magnetisable material, for example, a bar of soft iron which is capable of redirecting the magnetic field lines of a magnet which is placed near it. In the example illustrated, the coding element 59 is fixed to the upper end of the radial fan 39.

Conventionally, the Hall effect sensor 58 comprises a source element 61, such as a permanent magnet, which produces a magnetic field and an element 62 which is sensitive to the magnetic field of the source element 61. The sensitive element 62 which is supplied with electrical power, is the seat for a Hall voltage which is measured. This measurement is transmitted to the command element 51 to which the sensor 58 is connected.

The magnet 61 and the sensitive element 62 which are, for example, fixed to the printed circuit board 51, are spaced from each other so that the coding element 59, when rotated in a fixedly joined manner with the drive shaft 23, passes between the magnet 61 and the sensitive element 62. In this instance, only the two end portions of the bar forming a coding element 59 pass alternately between the magnet 61 and the sensitive element 62.

During its rotation, the coding element 59 thus influences the sensor 58 by varying the Hall voltage in the sensitive element 62.

It should be noted that the analysis of the variations of the Hall voltage in the sensitive element 62 allows access to the true speed value of the drive shaft 23.

The command element 51 is suitable, during operation of the motor, for receiving the desired speed value for the control element 55 and the measured speed value of the sensor 58, and for controlling the rotation speed of the motor relative to the desired speed by using the measured speed as a control variable.

The control and command device 50 further comprises an overload indicator 65, for example, a light indicator, as illustrated in FIG. 2, which is electrically connected to the command element 51.

The command element 51 is suitable for calculating the discrepancy between the set value and the measured value for the rotation speed of the drive shaft 23, received from the control element 55 and the sensor 58, respectively. The command element 51 activates the overload indicator 65, in this instance, brings about the emission of a light signal, when the discrepancy between the set value and the measured value of the speed exceeds a predetermined threshold value, for a first predetermined length of time.

For example, the overload indicator 65 will be able to be activated when the measured speed remains lower than the set value by from 10 to 20% (preferably 15%), for 1 minute or longer.

Optionally, the command element 51 can be suitable for cutting the electrical power supply to the motor 7 when the discrepancy between the desired speed and the measured speed exceeds this same threshold value (for example, from 10 to 20% and preferably 15%) for a second predetermined length of time which is greater than the first.

The second predetermined length of time can, for example, be in the order of 1 minute 30 seconds or 2 minutes.

Owing to this arrangement, the user can be made aware of a risk of the motor overheating and the motor can be automatically stopped when these risks of overheating become critical.

1. Electrical device for processing food products, comprising:
a housing,
an electric motor which has a rotary output shaft and which is arranged in the housing and is provided in order to drive a product processing element,
a control and command device for the motor, comprising a device for measuring the rotation speed of the drive shaft in a contactless manner,
wherein the measuring device comprises a Hall effect sensor which is fixedly joined to the housing, and an associated coding element, which is fixedly joined to the shaft in terms of rotation and which is provided in order to influence the sensor.

2. Device according to claim 1, wherein the Hall effect sensor comprises a source element which produces a magnetic field, in particular a permanent magnet, and an element which is sensitive to the magnetic field of the source element and which is spaced therefrom, the coding element passing, at least partially, between the source element and the sensitive element when it rotates in a manner fixedly joined to the shaft.

3. Device according to claim 1, wherein the control and command device comprises an element for controlling the desired speed of the motor, and a command element which is connected to the control element and to the Hall effect sensor and which is suitable for controlling the electrical supply to the motor in accordance with the desired speed value and the measured speed value.

4. Device according to claim 3, wherein the command element is suitable for controlling the speed of the motor relative to the desired speed using the measured speed as a control variable.

5. Device according to claim 4, wherein the command element is suitable for calculating the discrepancy between the set value and the measured value of the speed, and in that the control and command device comprises an overload indicator which is connected to the command element and which is activated thereby when the element determines that the discrepancy exceeds a predetermined threshold value for a first predetermined length of time.

6. Device according to claim 5, wherein the command element is suitable for cutting the electrical power supply to the motor when it detects that the discrepancy exceeds the predetermined threshold value for a second predetermined length of time.

7. Device according to claim 6, wherein the second predetermined length of time is greater than the first predetermined length of time.
